(19) United States
(12) Patent Application Publication
(10) Pub. No.: US 2007/0248115 A1
(43) Pub. Date: Oct. 25, 2007

(54) Distributed routing system and method

(75) Inventors: Steven Miller, Madison, AL (US); Enrique Hormigo, Port Washington, NY (US); David Leslie Ellgen, Madison, AL (US)

Correspondence Address: BUCHANAN, INGERSOLL & ROONEY PC, POST OFFICE BOX 1404, ALEXANDRIA, VA, 22313-1404, US

(73) Assignee: PESA Switching Systems, Inc., Huntsville, AL (US)

(21) Appl. No.: 11/785,245

(22) Filed: Apr. 16, 2007

Related U.S. Application Data
(60) Provisional application No. 60/793,644, filed on Apr. 21, 2006.

(51) Int. Cl. H04J 3/16

(52) U.S. Cl. 370/466

(57) ABSTRACT

Disclosed is a signal processing method and system for routing audio and/or video data. The signal processing system comprises an input device for receiving audio and/or video data over multiple input paths and for combining the data from the plural input paths into serial data of a serialized data block. A user interface for controlling a reordering of the serial data contained within the serialized data block is included within the signal processing system. The signal processing system also comprises an output device for distributing a first portion of the serial data in the serialized data block to a first output path and a second portion of the serial data of the serialized data block to a second output path.

### BACKGROUND

This application is directed to the routing of signals, in particular, audio signals.

Many applications require the routing of video and audio signals such as television networks, television and radio stations, mobile production facilities, government, industrial, commercial, educational and religious facilities. Video routing has been accomplished by using fully populated crosspoint matrix switches so that any video source can be routed to any of multiple destinations. This technique is also applied to routing of audio signals, but the cost can be high and approximately the same as routing video signals that require a much wider bandwidth.

In an effort to reduce the cost of routing audio signals, time division multiplexing has been used to route the digital audio signals. Time division multiplexing (TDM) multiplexes many low bandwidth audio signals into a single wide band signal that can be distributed to a single or multiple output distribution point.

Exact timing of the distribution routing points is important in TDM, or else the signal integrity can be destroyed. In large video and audio routing systems, the timing of the signals can become an issue when the signals are distributed over many feet of wire or cable and among several equipment chassis. In addition, TDM is also limited in standard systems by the number of signals that can be routed because of bandwidth requirements.

With the development of high-definition television systems, the synchronization between video and audio signals has become of greater importance. If the audio is not synchronized with the video signal, a lip-synchronization error occurs. Lip-synchronization errors are more readily identifiable in high-definition video. Such lip-synchronization errors can be very annoying to the user watching the high-definition video.

Data packet routing has been used in large systems that do not require exact real time audio routing. The relative cost can be much less than large crosspoint routers. However, errors which occur in packet routing are overcome by retransmitting the corrupted packet. This retransmission of the packet data can add to the system latency, thereby involving additional time for the transmission. Latency causes lip-synchronization errors due to the disruption of the relationship between the audio and video routing timing.

### SUMMARY

Disclosed is a signal processing system for routing audio and/or video data. The signal processing system comprises an input device for receiving audio and/or video data over multiple input paths and for combining the data from the plural input paths into serial data of a serialized data block. A user interface for controlling a reordering of the serial data contained within the serialized data block is included within the signal processing system. The signal processing system also comprises an output device for distributing a first portion of the serial data in the serialized data block to a first output path and a second portion of the serial data of the serialized data block to a second output path.

Also disclosed is a method for distributing a signal in a signal distribution system. The steps of the method comprise receiving data at a plurality of input devices and combining the received data into serial data of a serialized data block. The method comprises reordering the serial data contained in the serialized data block and distributing a first portion of the serial data in the serialized data block to a first output path and a second portion of the serial data of the serialized data block to a second output path.

### BRIEF DESCRIPTION OF THE DRAWING FIGURES

These and other features of the disclosed exemplary embodiments will become better understood with reference to the following description, appended claims and accompanying drawings where:

FIG. 1 shows an exemplary embodiment of a signal processing system;

FIG. 2 shows an exemplary embodiment of a signal processing system comprising a data exchange engine;

FIG. 3 shows an exemplary embodiment of a signal processing system using a redundant DXE module;

FIG. 4 shows an alternative embodiment of a signal processing system;

FIG. 5 shows a detailed block diagram of a data exchange engine; and

FIG. 6 shows a flowchart of an exemplary method.

### DETAILED DESCRIPTION

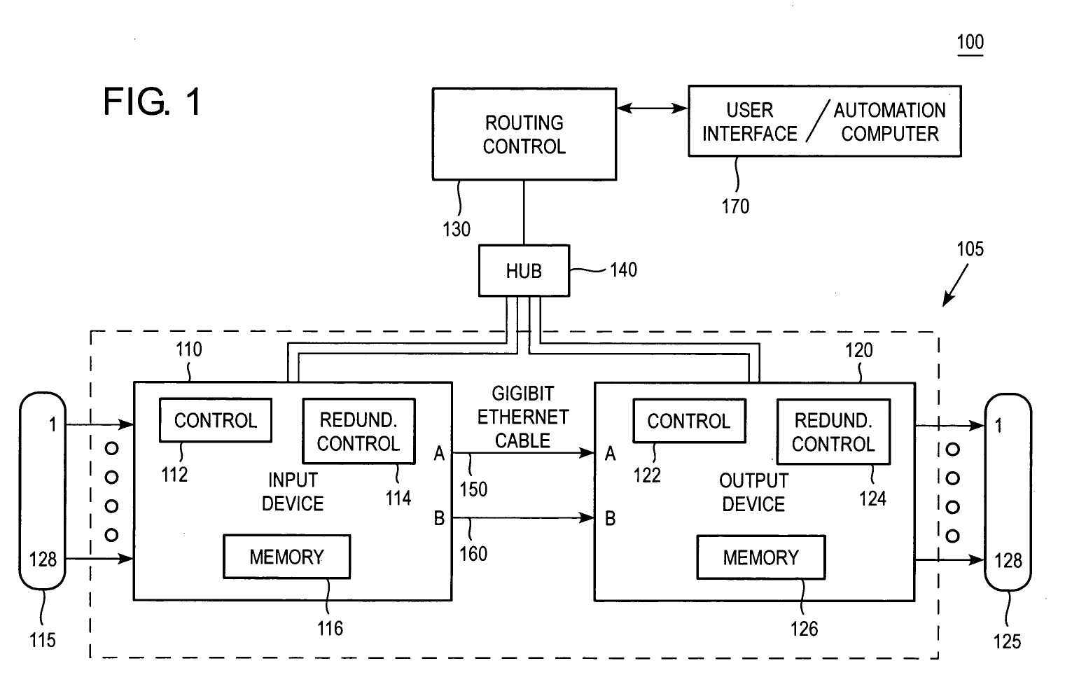

FIG. 1 illustrates a signal processing system 100 for distributing audio and/or video data. A signal processing system 100 comprises an input device 110, a user interface 170, and an output device 120. The signal processing system 100 comprises an input device 110 for receiving audio and/or video data from multiple input sources over multiple input paths 115 having inputs 1-128. The inputs can be 128 AES (AES3) audio inputs and for combining the data from the plural input paths 115 into serial data of a serialized data block. The AES inputs can be received and transmitted as audio pairs on unbalanced BNC connectors on 64 BNC connectors. The input sources need not be in parallel, but rather, can be located anywhere (e.g., separated by any suitable distance). Other connector options will be apparent to those skilled in the art.

Inputs and outputs can be AES unbalanced inputs or outputs, or any suitable inputs/outputs, on connectors, such as BNC connectors. Analog input signals are routed in the system by, for example, converting them to digital samples in input modules so they can be routed as digital signals through the DRS. In an exemplary embodiment, the signals can conform to the AES standard, whether digital inputs, or analog inputs that are converted from analog to AES digital signals. The output signals can be output as digital (e.g., AES digital signals or converted to analog prior to output).

The input device 110 comprises multiple input 115 connectors and input processing circuits. The system can be designed with more or less inputs per input device 110. In the input module 110, the 128 inputs are sample rate converted to 96 kHz, although other sample rates can be used. The sample word is 32 bits including 24 bits for accuracy of the audio sample plus standard status and parity bits included in the AES standard, or any other suitable sample word configuration. The 128 samples, or any desired portion of the samples, can be serialized into one bit stream that fits, for example, into the Gigibit Ethernet standard for transmission. A Gigibit Ethernet cable 150/160 is used for interconnection.

A circuit board can be configured as either an input module, output module, or part of the circuit board can be configured as inputs and the other part of the board as outputs.

The user interface 170 is used to control reordering of the serial data contained within the serialized data block. A user reorders the serial data by applying user selected inputs to the serial interface 170 via, for example, a mouse, keypad or dedicated control panels. Alternatively, or in addition, an automation computer can be used as the user interface 170 to reorder the serial data contained within the serialized data block.

The output device 120 can have any number of outputs (e.g., 128 AES (AES3) outputs). In an exemplary embodiment, the output device 120 may operate in one of two modes. In a first mode, the serial data input can be written into a memory and read out in an order that is determined by a control word generated by the user interface control 170. Using this process, routing control is achieved. In a second mode of operation the reordering of the serial data can take place elsewhere so the serial data is already formatted. A first portion of the serial data of the serialized data block can be distributed to a first output path 125 and a second portion of the serial data of the serialized data block to a second output path 125. The first output path and the second output path 125 can, for example, be any of the 1-128 outputs shown in output 125.

In an exemplary embodiment, the user interface 170 can output a control word based on inputs received from a user to reorder the serial data contained within the serialized data block. Alternatively, the automation computer 170 can output the control word. Routing control 130, which is optional, distributes the control word via a distribution device, such as Ethernet hub 140, to controllers located within the output devices 120. A different type of control word can be distributed to the input device 110 by the controller 122 located therein via the Ethernet hub 140. Each input device 110 and output device 120 can have a redundant controller 114 and 124, respectively. The control word that is distributed to the output device 120 can establish routing while the control word distributed to the input device 110 can be used to modify the input signal (e.g., to change the audio gain). The input device 110 can comprise plural input modules and/or the output device 120 can comprise plural output modules.

The signal processing system 100 comprises a memory 126 for storing the serial data in the serialized data block. In the embodiment illustrated in FIG. 1, the memory 126 is shown configured within the output device 120. However, this is an exemplary location, as the memory 126 may be located external of the router 105 or in any of the device. The memory 126 can, for example, be a single memory, a group of memories or a partition of a larger memory. Every input device 110 and every output device 120 can have its own separate memory.

The memory 116 shows in the input device 110 can be used to create the serial data stream by writing multiple inputs (e.g., at a relatively slow rate, low bandwidth) into the memory and reading them out (e.g., at a much higher rate, wider bandwidth) from each memory location in sequence. In the output device, the memory 126 can be written at a high data rate in sequence and read at a high data rate in a sequence determined by the control word.

In the FIG. 1 embodiment, the inputs 115 are written into the memory 116. The stored serial data can be read from the memory 116 at high speed in, for example, the order of the memory addresses or any other suitable order. In an exemplary embodiment, input number one is written into the first memory location, the second input to the second location, and so on. One sample word from each input point is collected in order and transmitted in one packet with a header and checksum added. The process is then repeated. The header is added to, for example, identify the start of each packet so that the input channels can be identified by the output device 120. In an exemplary embodiment, this creates a packet of 128 words of 32 bits, not including the header and checksum. Alternatively, smaller packets can be created by collecting the first 32 inputs into a word, then the next 32 inputs, and so on until all 128 inputs have been transmitted.

Another method is to read the memory 126, so that the least significant bit (LSB) is read from the first input. The LSB from the second input is then read, and so on until all 128 LSBs are read into a packet for transmission. The second LSB can be collected from all inputs and so on until all bits of all memory locations are transmitted. The process can be repeated for the next sample of all 128 inputs. Alternately the most significant bits (MSBs) can be read in order. An exemplary embodiment uses the method of constructing a packet of all 32 bits of each input sample word. The system delay can be minimized, and the timing relationship between all channels can be maintained in the process.

The control word output from the user interface/automation computer 170 can be distributed via routing control 130 and hub 140 to the controller 122 of the output device 120. The hub 140 is an optional hub or Ethernet switch that is used to distribute bi-directional control and monitoring signals to and from single, or multiple, input devices 110 and output devices 120.

The control signals to the input devices 110 are generally used to control gain or other processing of the signal. The control signal may come into a separate port as shown or it may be part of the bi-directional control words that are sent over the data path. The data is, for example, unidirectional, but the control signals may be bi-directional. The input device 110 does not receive routing control when, for example, it does not perform any of the distribution function.

The input device 110 serializes the input samples in sequence with a word start header. The distribution of any input to any output or combination of outputs takes place in the output device 120 in a basic system with only one input device 110 and one output device 120. The router 105 can comprise a minimum of one input device 110 and one output device 120 or one device that has both inputs and outputs such as 64 inputs and 64 outputs.

In the output device 120, the control word can be used to create a mask identifying memory locations of the serial data in the memory 126. In an embodiment, memory 126 is configured as a lookup table so that the control word is used as an address and the data output is used to address the memory 126. Each output device 120 can read from any memory location so that each output can be selected from different sources or several or all outputs can be selected from any input to the input device 110. The output devices 120 uses the created mask to distribute a first portion of the serial data in the serialized data block to a first output path 125 and a second portion of the serial data of the serialized data block to a second output path 125. The first and second output paths 125 can be any one or more of the 128 outputs of the output device 120.

Input device 110 and output device 120 can be co-located in a router 105. The router 105 can have input devices 110 and output devices 120 mounted on a common PC board, a common module that is rack-mountable, a common chassis, which is also located in a rack or any other device. When the input device 110 and output device 120 are located on a common PC board, the input device 110 and the output device 120 can share the 128 inputs or outputs, in which case, any of the 128 inputs or outputs can be designated as an input or output. The 128 inputs and outputs can be configured into 64 inputs and 64 outputs. For instance, a circuit board used in an embodiment can be configured to be used as either an input module or output module.

When the input device 110 and the output device 120 are configured as a common PC board, one half of the board is configured as an input device 110 and the other half is configured as an output device 120, so that a complete router 105 with 64 inputs and 64 outputs exists on a circuit board in a single small chassis. Such a system 100 can use frame controllers to pass Protocol 2 (P2) requests from either device or a higher level control system. In the common PC board configuration of router 105, the controllers 112 and 122 send messages to the output module 120 to perform the reordering of the serial data stored in memory 126.

The input device 110 and the output device 120 can be located on individual chassis separated by hundreds of feet or possibly miles. As shown in FIG. 1, gigabit Ethernet cables 150 and 160 can connect the input device 110 with the output device 120. Gigabit Ethernet cable 160 is shown as a redundant cable that provides the same information as gigabit Ethernet cable 150. In this configuration, the input device controller 112 does not control the reordering of the data. The input device controller 112 is used to exchange status or controller information with the output device controller 122 by embedding control data in the data sent via the gigabit Ethernet cable 150. In the case of a malfunction, redundant control 114 of the input device 110, can take over the functions of the input device control 112. Similarly, redundant control 124 can assume the functions of the output device controller 122. The memory 126 of the output device 120 is used for storing the received audio and/or video data from the input device 110.

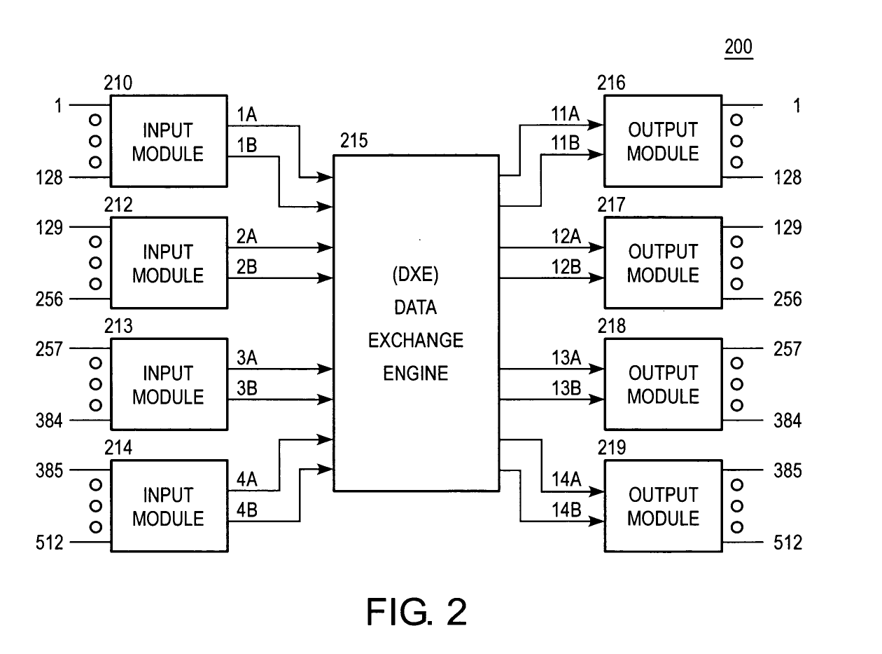

In an alternative embodiment, the signal processing system may include a data exchange engine. FIG. 2 shows a signal distribution system with a Data Exchange Engine (DXE) 15 interconnecting 4 input devices 10-14 and 4 output devices 16-19. The DXE 15 provides cross routing from any signal in any of the 4 groups of inputs to any of the 4 output devices 16-19. The dual inputs 1A, 1B . . . 4A, 4B and outputs 11A, 11B . . . 14A, 14B are redundant and can be used to improve reliability of the IO and transmission path. For example, data paths 1A and 1B contain exactly the same data and are used to connect the input device 10 to the DXE 15. All other input and output modules can be interconnected by redundant transmission paths. This can be done to, for example, increase the reliability of the system in environments where the transmission path or connectors may be prone to failure and it is very important to maintain continuous operation.

The DXE 15 is used to consolidate multiple input devices 10-14 and distribute only the required signals to the desired output devices, for instance, output device 16. Several outputs from the DXE 15 are used to distribute the desired signals to several different output devices, for instance, output devices 17-19. This can be done to distribute the various components of the routing system for various reasons. One is to eliminate the possibility of a single point failure that can disable the entire signal distribution. Another is to distribute a limited number of packets on each transmission path so that the bandwidth capability is not exceeded on any of the transmission paths. The single DXE 15 illustrated in FIG. 2 gives the capability of expanding the system to 512 inputs and 512 outputs with relatively low cost, low power and small size.

The reordering of the serialized data occurs on the DXE so the output device writes and reads the data in a normal 1 through 128 sequence. The output samples are written into a first-in first-out (FIFO) memory in a high speed burst and read from the FIFO at 96 kHz for high speed or decimated by 2×1 and read at 48 kHz for standard AES data rates.

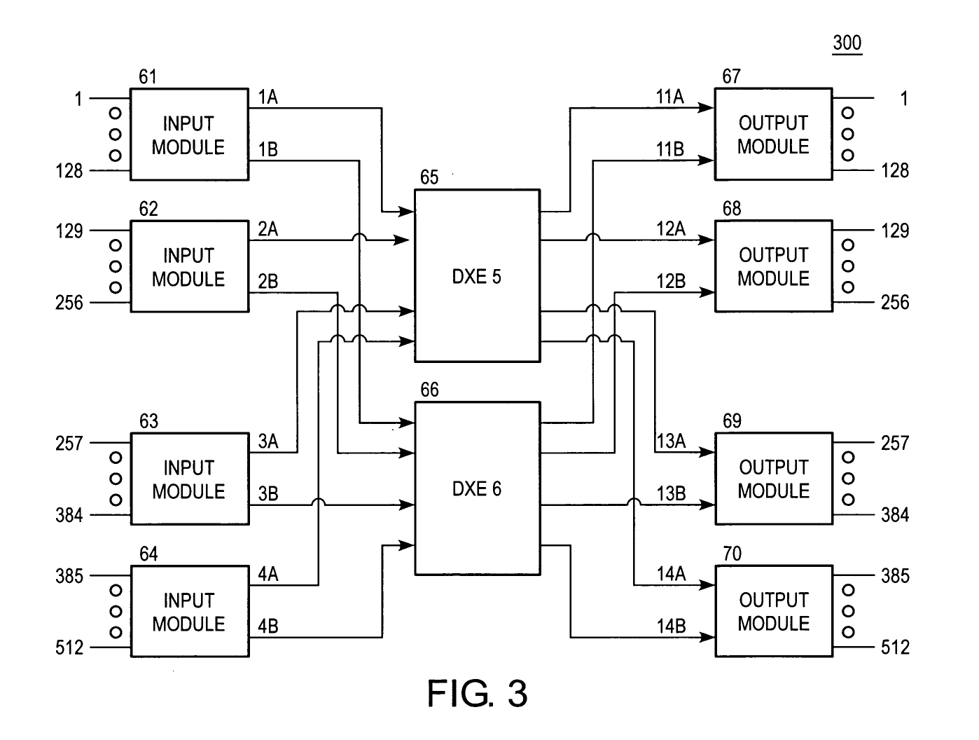

FIG. 3 shows a system or 512 inputs to 512 outputs using a redundant DXE module 66. This system demonstrates the use of the redundant outputs 11B-14B and inputs 1B-4B. The dual outputs of the input modules 61, 62, 63 and 64 are used to drive redundant DXE modules 65 and 66 to, for example, improve reliability of the system. The redundant DXE modules are used to drive the redundant inputs of the output modules 67, 68, 69 and 70. This cross connection allows for normal system operation of the system in the event of failure of any one or more transmission paths or failure of one of the DXE modules.

The basic function of the DXE is to consolidate input modules with up to 128 inputs in each input module and drive output modules with 128 outputs each.

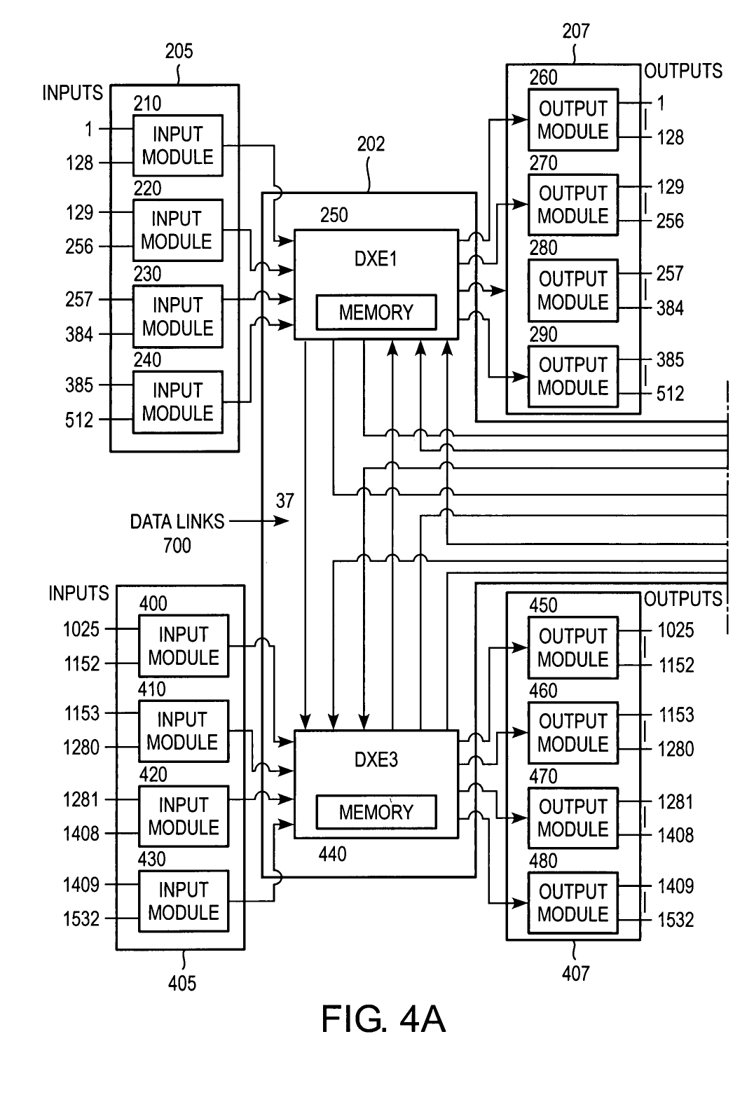

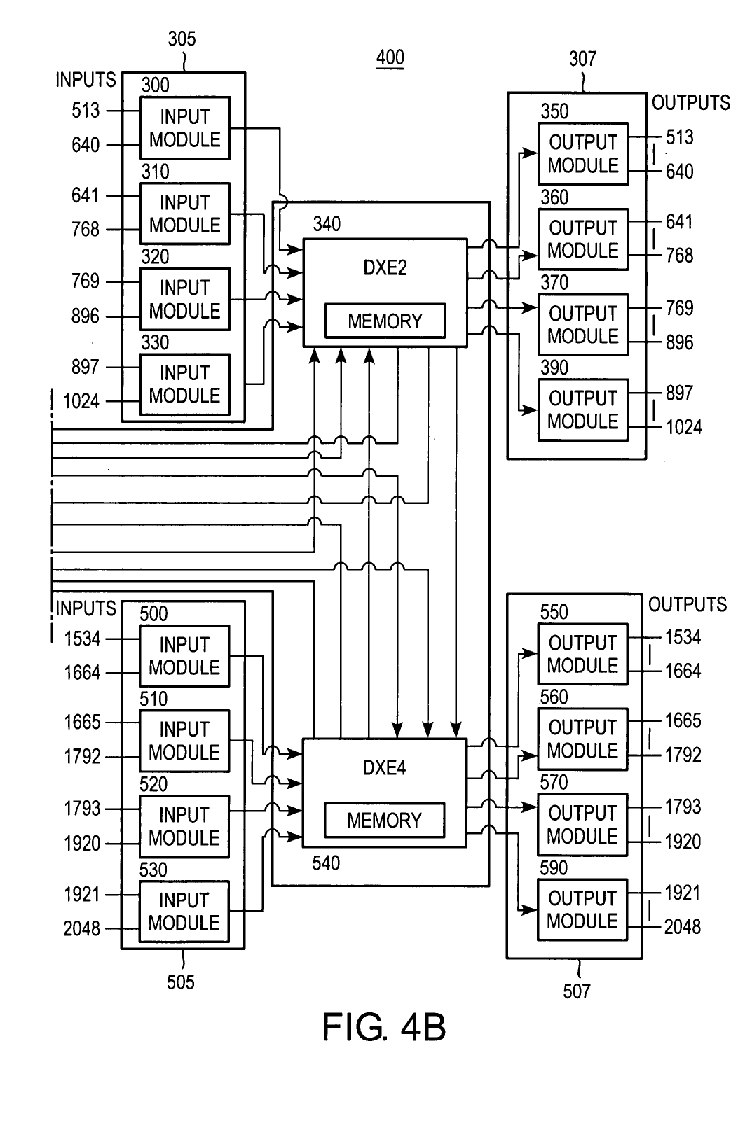

As shown in FIG. 4, the signal processing system 200 comprises input devices 205, 305, 405 and 505; output devices 207, 307, 407 and 507; and a data exchange engine 202. The data exchange engine 202 accommodates plural input devices 205-505 and plural output devices 207-507.

Each of the input devices 205, 305, 405 and 505, comprise individual input modules. For instance, input device 205 comprises input modules 210, 220, 230 and 240. Similarly, output device 207 comprises multiple output module 260, 270, 280 and 290. The other input devices 205, 405 and 505, and output devices 307, 407, and 507, are similarly configured. The data exchange engine 202 can also be connected to a user interface/automation computer. The data exchange engine 202 is connected to the plural input devices 205, 305, 405 and 505 to receive plural parallel audio and/or video data.

Data exchange engine 202 can comprise multiple interconnected, distributed data exchange engines shown as data exchange engines (DXE) 250, 340, 440 and 540 to expand the system to, for example, 2048 inputs routed to 2048 outputs. In addition, redundant interconnections from DXE 250 to output modules 260, 260, 280 and 290 of input module 207 can be added for additional reliability. In the FIG. 4 embodiment, each of the 4 DXEs is interconnected to the other 3 DXEs by a send path and a receive path. An optional redundant send and receive path can also be used. Each send and receive path comprises optical fiber links to carry the data at approximately 2 Gigibits or any other suitable bandwidth. These transmission paths are also single or redundant for reliability. Other high bandwidth transmission cables may be used in place of the optical fiber links, such as coaxial cable.

Each DXE 250, 340, 440 and 540 can have 4 inputs from DXEs external to DXE 202 and 4 outputs to DXEs external to DXE 202 so that a system as shown can have up to 2660 inputs and 2660 outputs with 5 interconnected DXEs.

FIG. 3 is shown as 4 interconnected DXE modules to simplify the drawing. A larger DXE 202 with more inputs and outputs could be used in place of multiple DXEs, however, the use of multiple distributed DXEs help distribute the system over several chassis to reduce the percentage of a system that is lost in the event of a failure in any one chassis. An exemplary embodiment can use the distributed system to improve reliability by using multiple chassis and control units so that no single failure can cause a widespread system failure.

System control can be accomplished by sending control signals to each individual DXE, input module or output module or by sending control signals to an output module and embedding the control signals into the data path and sending it back to DXEs 202 and input modules. The DXEs 202 can embed the control signals in the data paths to the input modules or other DXEs 202.

The data exchange engine 202 receives a control word from the user interface and distributes the serial data using the control word by creating a mask identifying memory locations of the serial data for distribution. The memory devices within the data exchange engine 202 are used to store the received audio and/or video data that has been serialized in the input devices 205, 305, 405 and 505. In response to the creation of the mask identifying memory locations of the serial data, portions of the serial data in the serialized data block are output to a first output path and/or a second output path from any one of the outputs from output devices 207, 307, 407 and 507.

The data exchange engine 202 shown in FIG. 4 comprises four data exchange devices 250, 340, 440 and 540. Each of the exemplary data exchange devices 250, 340, 440 and 540, can be connected by two gigabit fiberlinks, or alternatively, one gigabit Ethernet links capable of exchanging data at, for example, 800 Mb/s each. In this configuration, the control of the operations is performed by controllers within the data exchange devices 250, 340, 440 and 540, rather than controller of the input devices, or the output devices. However, the input devices and output devices exchange status information and set control information with the controllers in the data exchange devices via gigabit links.

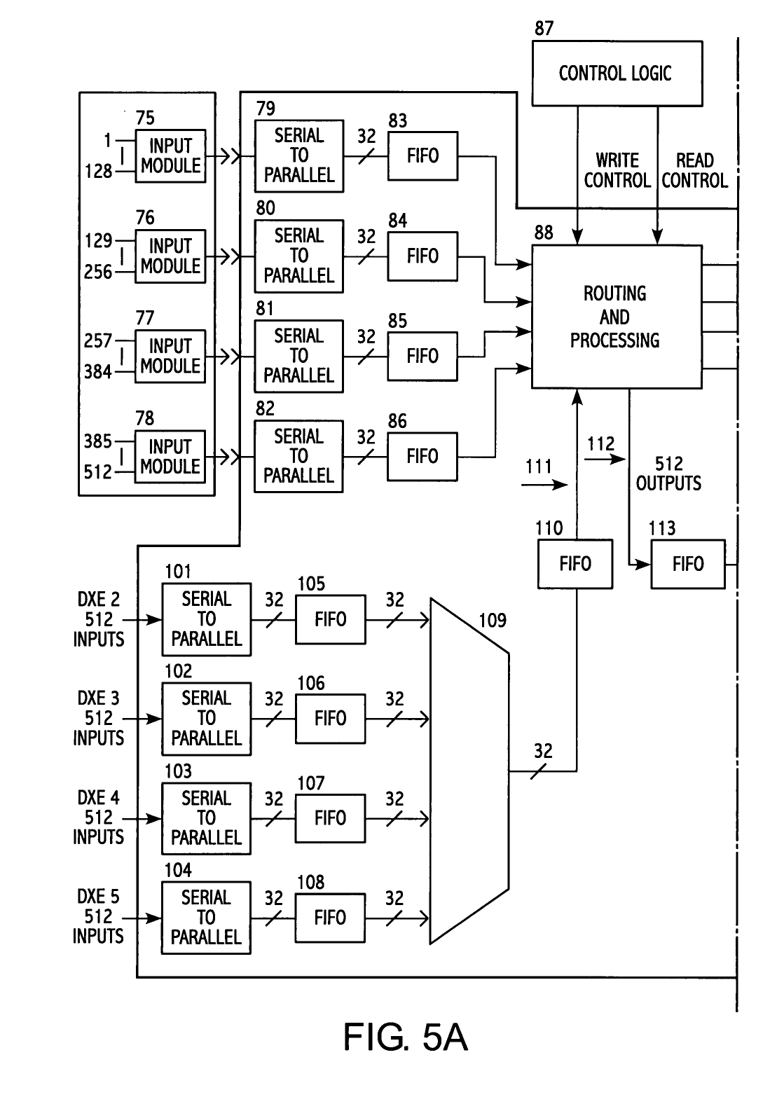

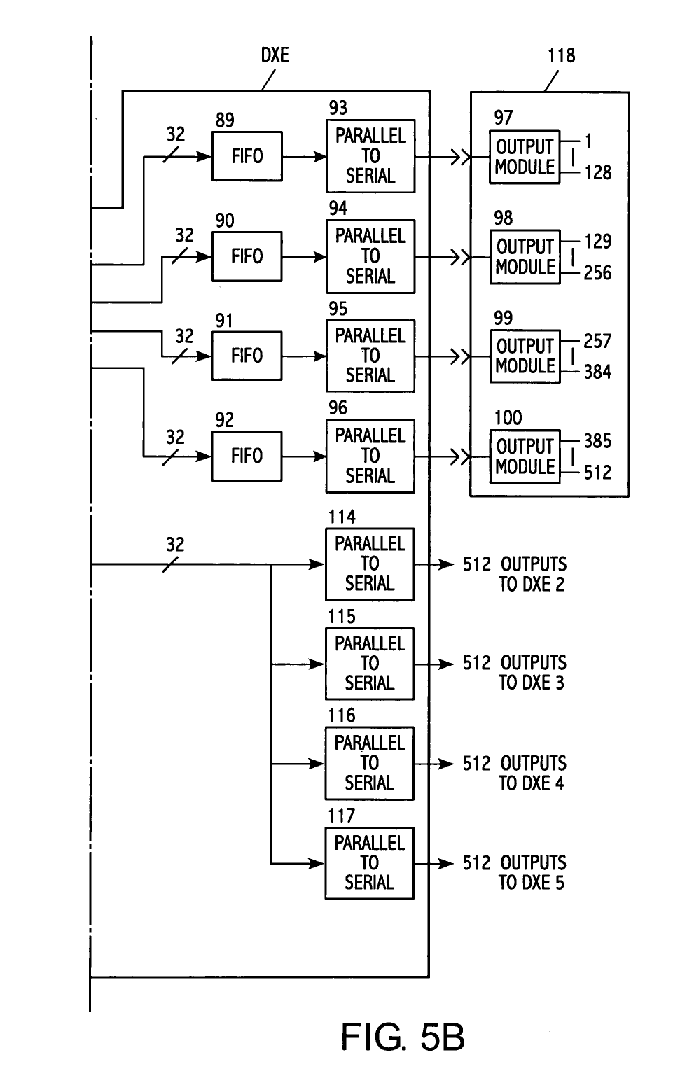

FIG. 5 shows a more detailed block diagram of a DXE, such as DXE 250 of FIG. 4. In this embodiment, there are 4 local inputs from the 4 external input modules 75-78, and each of the 4 local inputs contains up to 128 AES type signals with each signal being 32 bits at a sample rate of 96 kHz serialized in packets of 128 words. The serialized inputs can be converted to parallel samples of 32 bits by the serial-to-parallel converters 79-82 to, for example, reduce the data rate. The serial-to-parallel conversion and processing can take place in a field programmable gate array (FPGA), although other suitable circuiting may be used. Routing circuit 88 can be a fast dual port memory with serial write addressing and reordered read addressing to reorder the output samples according to the routing desired. The write and read addresses can be created by the Control Logic 87. The signal distribution takes place in routing circuit 88. In an exemplary embodiment, the memory addresses are read in an order determined by the control logic 87 so that the output data stream is in the order of the desired distribution of the individual outputs of the individual output modules 97-100.

For example, the first word read will go to the first output of output module 97, and the second word will go to the first output of output module 98, and so on until all 128 words are read for all 4 output modules for a total of 512 output locations. The routing circuit 88 can incorporate another read cycle that selects inputs to an audio processing module and audio mixer circuit to enable the routing circuit 88 to perform some mixing and cross fading of a limited number of signals. The output of the mixers can be multiplexed into the date streams driving the 4 local output modules 97-100.

The FIFO memories 83-86 at all the inputs of router 88 can meter the input data to match the write cycles, and the FIFO memories 89-92 at the output of routing circuit 88 can meter the outputs to match the transmission rate. The dual port memory in routing circuit 88 can operate in bursts from the various FIFO memories. The local outputs can be metered by FIFOs 89, 90, 91 and 92 to the parallel-to-serial converters 93-96. In an exemplary embodiment, the serialized outputs can drive up to 4 external output modules 97-100.

The data output to the serial outputs can be reordered by manipulating the read address of the dual port memory in the routing and processing block. The dual port memory can be configured as a high speed 32 bit wide memory with multiple reads and writes to accommodate the multiple inputs and outputs. Alternate configurations are possible, such as wider words to reduce memory read and write speed requirements, or narrower words to take advantage of a much faster, but narrower memory.

Four high speed inputs into the DXE and four high speed outputs from the DXE are provided to exchange data with DXEs 2-5 so the system can be expanded beyond 512 inputs and 512 outputs. Each of the high speed inputs contains up to 512 audio signal inputs. The 4 high speed inputs are converted from serial-to-parallel converters 101-104. The parallel data rate is approximately 50 MHz in an exemplary embodiment. The FIFOs 105-108 are used to meter the signals into the pre-selector 109. The pre-selector 109 selects 512 inputs from the 4 groups of 512 inputs each. The inputs are serialized so that each input has a specific place in each input word. The control logic 87 keeps track of the addresses or the time slots of each input signal. The pre-selector 109 receives selection control signals to dynamically choose the desired inputs on a word basis. The outputs of FIFOs 105-108 are controlled in conjunction with the selection of the inputs of the pre-selector 109 to align the data so it can be selected in the desired order. The output of the pre-selector 109 is 512 sequential signals 32 bits wide. The pre-selector 109 drives FIFO 110 that meters the input to the routing circuit 88. In an exemplary embodiment, the data rate is approximately 50 MHz, which is limited by the implementing devices.

The 512 input signals output from FIFO 110 are written into a dual port memory in the routing circuit 88 in a multiplexed sequence along with the 512 inputs from the input modules 75-78. There are two types of reads from the memory. The first is the 4 groups of 128 local signals that drive the output modules 97-100 as previously described. These outputs may be read from any of the 1024 inputs from the 2 groups of 512 inputs remembering that any signal available to the input of the pre-selector may be selected as part of the second group of 512 inputs. The second is the 512 sequential outputs of 32 bits that are used to form the serialized outputs that drive the other DXD modules 2-5. The outputs of the other DXE modules 2-5 may be selected from the 512 local inputs, but the circuitry is not necessarily limited in that way. The output of FIFO 113 drives the same signal to all 4 serial-to-parallel converters 114-117. An alternate method is to use a single serial-to-parallel converter that in turn drives 4 cable drivers; however the use of separate serial-to-parallel converters provides more redundancy.

The cable drivers may drive redundant output connectors and redundant transmission paths to redundant DXE modules. Any DXE 1-5 in the system may be connected in parallel with a redundant DXE as shown in FIG. 4. However, all or none of the DXEs can be made redundant depending on the budget and how critical the separate groups of inputs and outputs are in the system. The inputs are made redundant by duplicating the input serial-to-parallel 101-104. Alternate methods may be employed such as a 2 by 1 selector switch in front of the serial-to-parallel converters 79-82.

The outputs of the DXEs 2-5 are serialized in the predetermined read order to form a wide bandwidth signal that is transmitted on redundant transmission paths to the output modules. The formatting is such that the first sample word goes to output 1 of that output module, sample 2 goes to output 2 of that output module, and so on.

Each of the local output channels from local output device 118 has a corresponding FIFO memory that buffers the packets being sent to the output modules 97-100. Redundant input connectors are provided from each input module 119 to the DXE and redundant output connectors are provided from the DXE to drive each output module to improve system reliability. This allows the system to be tolerant of cable or other transmission path faults. It also allows for full redundancy of DXE processors simply by connecting independent DXEs to each of the redundant cables of the input and output modules as shown in FIG. 4. Alternately, it allows for a double-sized routing matrix using the same DXE size instead of the redundancy.

Alternatively, partial redundancy is provided by dual inputs to each DXE input with error checking so a better signal can be selected automatically or by an operator without the error checking circuitry. Different alternatives may be provided on different systems depending on the degree of redundancy required.

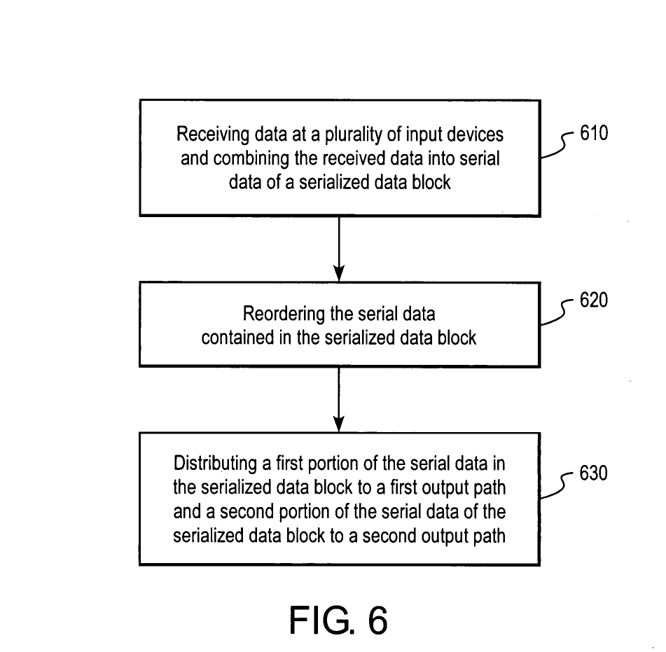

FIG. 6 illustrates exemplary steps of a method for distributing a signal in a signal distribution system. In step 610, data is received at a plurality of input devices and combined into serial data of a serialized data block. Once the serialized data block is combined in an output device, it is forwarded to an output device, such as output device 120. Alternatively, the serialized data block can be forwarded to a data exchange engine 202 or to a data exchange device, such as data exchange device 250 within the data exchange engine 202.

Within the output device 120, or data exchange engine 202, the serial data contained in the serialized data block is reordered (620). From either the upward device 120, or the data exchange engine 202, a first portion of the serial data in the serialized data block is distributed to a first output path. Similarly, a second portion of the serial data of the serialized data block is distributed to a second output path (630).

It would be appreciated by those skilled in the art that the present invention can be embodied in other specific forms without departing from the spirit or essential characteristics thereof. The presently disclosed embodiments are there for considered and all respect to be illustrative. The scope of the invention is indicated by the appended claims rather than the foregoing description and all changes that come within the meaning and range and equivalence thereof are intended to be embraced therein.

What is claimed is:

1. A signal processing system for routing audio and/or video data, comprising:
an input device for receiving audio and/or video data over parallel input paths and for combining the data from the plural input paths into serial data of a serialized data block;
a user interface for reordering the serial data contained within the serialized data block; and
an output device for distributing a first portion of the serial data in the serialized data block to a first output path and a second portion of the serial data of the serialized data block to a second output path.

2. The system of claim 1, comprising:
a data exchange engine accommodating plural input devices and plural output devices, and connected to the user interface.

3. The system of claim 2, wherein the data exchange engine is connected to plural input devices, plural output devices to distribute the serial data.

4. The system of claim 3, wherein the data exchange engine receives a control word from the user interface and distributes the serial data using the control word.

5. The system of claim 4, wherein the user interface outputs the control word to the data exchange engine to create a mask identifying memory locations of the serial data.

6. The system of claim 1, wherein the input device comprises plural input modules.

7. The system of claim 1, wherein the audio and/or video data received over the parallel input paths is audio and/or video feeds in a real-time broadcast.

8. The system of claim 7, wherein the video data includes textual data.

9. The system of claim 1, wherein the reordering performed by the user interface includes assigning a portion of the serial data to a particular output path.

10. The system of claim 9, wherein an automation computer is used as the user interface to reorder the serial data contained within the serialized data block.

11. The system of claim 1, wherein the output device comprises plural output modules.

12. The system of claim 1, comprises:
a memory for storing the serial data in the serialized data block.

13. The system of claim 12, wherein the user interface outputs the control word to the output modules to create a mask identifying memory locations of the serial data.

14. The system of claim 1, wherein the input device and output device are configured on a common substrate, or in a common module, or in a common chassis.

15. A method for distributing a signal in a distribution system, comprising:
receiving data at a plurality of input devices and combining the received data into serial data of a serialized data block;
reordering the serial data contained in the serialized data block; and
distributing a first portion of the serial data in the serialized data block to a first output path and a second portion of the serial data of the serialized data block to a second output path.

16. The method of claim 14, comprising:
accommodating plural input devices, plural output devices and plural data exchange engines, and connected to a user interface using a data exchange engine, wherein the data exchange engine comprises a memory.

17. The method of claim 15, wherein the data exchange engine facilitates the distribution of the portions of the serial data to the first and second output paths.

18. The method of claim 16, wherein the data exchange engine receives a control word from the user interface and routes the serial data based on the control word.

19. The method of claim 17, comprising:
outputting a control word from a user interface to a data exchange engine; and
creating a mask based on the control word identifying memory locations containing serial data, which is to be distributed to the first output path and the second output path, respectively.

20. The method of claim 14, wherein the input device comprises one or more input modules, wherein the one or more input modules are connectable to a data exchange engine.

21. The method of claim 14, wherein the audio and/or video data received over the parallel input paths is audio and/or video feeds in a real-time broadcast.

22. The method of claim 14, wherein the reordering comprises:
assigning a portion of the serial data to a particular output path.

23. The method of claim 21, wherein the reordering is performed by an automation computer.

24. The method of claim 14, wherein the output device comprises one or more output modules having memory for storing the serial data in the serialized data block, wherein the one or more output modules are connectable to a data exchange engine.

25. The system of claim 1, comprising:
multiple data exchange engines for accommodating plural input and output devices, wherein a control signal for the multiple data exchange engines is embedded as a bi-directional control signal in the signal data path.
